(19) United States
(12) Patent Application Publication
(10) Pub. No.: US 2014/0297056 A1
(43) Pub. Date: Oct. 2, 2014

(54) TEMPERATURE CONTROLLER

(71) Applicant: NIHON DEMPA KOGYO CO., LTD., TOKYO (JP)

(72) Inventors: KAZUO AKAIKE, SAITAMA (JP); TSUKASA KOBATA, SAITAMA (JP)

(73) Assignee: NIHON DEMPA KOGYO CO., LTD., TOKYO (JP)

(21) Appl. No.: 14/226,825

(22) Filed: Mar. 27, 2014

(30) Foreign Application Priority Data
Mar. 28, 2013 (JP) 2013-069731

(51) Int. Cl. G05D 23/19

(52) U.S. Cl. CPC G05D 23/19
USPC 700/300

(57) ABSTRACT

A temperature controller for controlling a temperature of a heated body heated by a heater to a target temperature. The temperature controller includes a temperature detection unit, a difference computation unit, a controller, a comparison unit, an abnormal event detection unit, and a power feeding stopping unit. The abnormal event detection unit is configured to output a second signal that is an abnormal event detection signal when the first signal continues to be output for a period of time exceeding a pre-set period of time. The power feeding stopping unit is configured to stop power feeding to the heater when the second signal is output. The power feeding amount to the heater is controlled based on the manipulated variable computed by the controller.

### CROSS-REFERENCE TO RELATED APPLICATION

This application claims the priority benefit of Japanese application serial no. 2013-069731, filed Mar. 28, 2013. The entirety of the above-mentioned patent application is hereby incorporated by reference herein and made a part of specification.

### BACKGROUND

1. Technical Field

This disclosure relates to a temperature controller that controls a temperature of a heated body heated by a heater to a target temperature and stops power feeding when an abnormal event occurs in the temperature control.

2. Description of the Related Art

When heating an electronic component to a constant temperature by a heater to stabilize the characteristics of the electronic component, using, what is called, an oven controlled crystal control oscillator (OCXO) is one option. Since a crystal unit changes its frequency in response to the temperature, such a type of crystal oscillator is used when an output frequency with high stability is required. The OCXO is required to prevent a heater from overheating when the temperature cannot be controlled appropriately due to a failure of such as an electronic circuit or a heater. Therefore, for example, an analog circuit is provided that stops power feeding to the heater when a temperature value detected by a thermistor reaches a threshold value corresponding to an abnormal value.

Incidentally, if the above-described threshold value is too far from the ordinary temperature range, the detection of abnormal event in the temperature control is delayed. In contrast, if the above-described threshold value is too close to the ordinary temperature range, it is difficult to identify whether an abnormal value is due to a failure of a temperature control loop or a sudden temperature change. In addition, since the OCXOs have different sizes of housings and different layouts of electronic components corresponding to their types, the OCXOs are required to set their own threshold value every type for determining that a detected temperature value is abnormal. Furthermore, since an abnormal detection circuit is an analog circuit, it is cumbersome and difficult to adjust the above-described threshold value with high accuracy in initial adjustment by manufacturers.

Japanese Unexamined Patent Application Publication No. H8-262923 (paragraph 0009) (hereinafter referred to as Patent Literature 1) discloses a circuit that detects the temperature near a fixing unit of an electro-photographic machine using a thermistor, and forcibly stops power feeding to a heater when a temperature detection value reaches an abnormally high temperature. Such an abnormal event detection system, however, cannot solve the above-described problem. Japanese Unexamined Patent Application Publication No. 2004-88776 (claim 5) (hereinafter referred to as Patent Literature 2) discloses a circuit that calculates a difference value between a temperature detection value of a temperature sensor and a temperature reference value using a temperature comparison unit, and converts the calculated difference value from an analog signal to a digital signal, then performs a Proportional-Integral-Derivative (PID) control such that the digitalized difference value becomes zero. Patent Literature 2, however, does not disclose a technique for detecting an abnormal event of a temperature control unit. Japanese Unexamined Patent Application Publication No. 2012-170050 (paragraph 0024) (hereinafter referred to as Patent Literature 3) discloses a technique for detecting, as a digital value, a temperature using a crystal unit, however the disclosure of the applicable fields of is limited.

This disclosure have been made in view of the aforementioned problems, and an object of the disclosure is to provide a temperature controller that may easily set, with high accuracy, the threshold value corresponding to a situation in which the temperature is not controlled appropriately.

### SUMMARY

A temperature controller for controlling a temperature of a heated body heated by a heater to a target temperature according to this disclosure includes a temperature detection unit, a difference computation unit, a controller, a comparison unit, an abnormal event detection unit, and a power feeding stopping unit. The temperature detection unit is configured to detect the temperature of the heated body. The difference computation unit is configured to compute a difference value between a temperature detection value detected by the temperature detection unit, and a temperature setting value corresponding to the target temperature. The controller is configured to compute a manipulated variable to make the difference value computed by the difference computation unit zero. The comparison unit is configured to compare the difference value computed by the difference computation unit with a pre-set threshold value set for detecting an abnormal event in the temperature control, and output a first signal when the difference value exceeds the threshold value. The abnormal event detection unit is configured to output a second signal that is an abnormal event detection signal when the first signal continues to be output for a period of time exceeding a pre-set period of time. The power feeding stopping unit is configured to stop power feeding to the heater when the second signal is output. A power feeding amount to the heater is controlled based on the manipulated variable computed by the controller.

The above-described temperature controller may have the following features.

(a) The heated body is an electronic component.

(b) The controller computes the manipulated variable with respect to the difference value by PI operation.

(c) The difference computation unit is configured to output the difference value as a digital signal, the temperature setting value and the difference value are digital signals, and the comparison unit compares the threshold value as a digital signal with the difference value.

(d) in (c), The temperature detection unit includes: a first crystal unit including a first electrode provided on a crystal element; a second crystal unit including a second electrode provided on the crystal element; a first oscillator circuit and a second oscillator circuit respectively connected to the first crystal unit and the second crystal unit; and a frequency difference detection unit configured to compute, as the temperature detection value, a value corresponding to a difference value between a value corresponding to a difference between f1 and f1r, and a value corresponding to a difference between f2 and f1r, assuming that an oscillation frequency of the first oscillator circuit is f1, an oscillation frequency of the first oscillator circuit at a reference temperature is f1r, an oscillation frequency of the second oscillator circuit is f2, an oscillation frequency of the second oscillator circuit at the reference temperature is f2r. The frequency difference detection unit includes: a pulse generation unit configured to generate a pulse having a frequency corresponding to a difference between f1 and f2; a DDS circuit unit configured to output a frequency signal whose signal value repeatedly increases and decreases with time at a frequency in response to an magnitude of an input DC voltage; a latch circuit configured to latch the frequency signal output from the DDS circuit unit using the pulse generated by the pulse generation unit; a loop filter configured to integrate a signal value latched by the latch circuit, and outputs the integrated value as a value corresponding to the difference value; and an addition unit configured to extract a difference between an output of the loop filter and a value corresponding to a difference between f1r and f2r, and set the extracted difference as an input value to the DDS circuit unit. The heated body heated by the heater is the crystal units.

According to this disclosure, the temperature controller for controlling a temperature of a heated body heated by a heater to a pre-set temperature computes a manipulated variable such that a difference value between a temperature detection value and a temperature setting value becomes zero, and determines a power feeding amount based on the computation result. Focusing on the fact that the above-described difference value is near zero in the normal operation, but becomes larger than that in the normal operation when the temperature is not controlled appropriately, the temperature controller determines that an abnormal event occurs in the temperature control if the difference value exceeds the threshold value for a pre-set period of time, then stops power feeding to a heater. Therefore, the temperature controller may easily set, with high accuracy, the threshold value corresponding to a situation in which the temperature is not controlled appropriately.

### BRIEF DESCRIPTION OF THE DRAWINGS

FIG. 1 is a block diagram illustrating a temperature controller according to an embodiment of this disclosure.

FIG. 2 is a block diagram illustrating a frequency difference detection unit provided in the temperature controller.

FIGS. 3A to 3D are an explanatory view of the input and output waveforms of the frequency difference detection unit.

FIGS. 4A to 4C are waveform views of respective units schematically illustrating a state where a loop including a DDS circuit unit of the frequency difference detection unit is unlocked.

FIGS. 5A to 5C are waveform views of respective units schematically illustrating a state where the loop including the DDS circuit unit is locked.

FIGS. 6A and 6B are waveform views of respective units in the loop of an actual device corresponding to the embodiment.

FIG. 7 is a characteristic view illustrating a relation between a digital output value of a frequency difference detection unit and a temperature.

FIGS. 8 A to 8D are a timing chart of operation of the temperature controller to stop power feeding to a heater.

FIG. 9 is a block diagram illustrating an oscillating device including the temperature controller of this disclosure.

### DETAILED DESCRIPTION

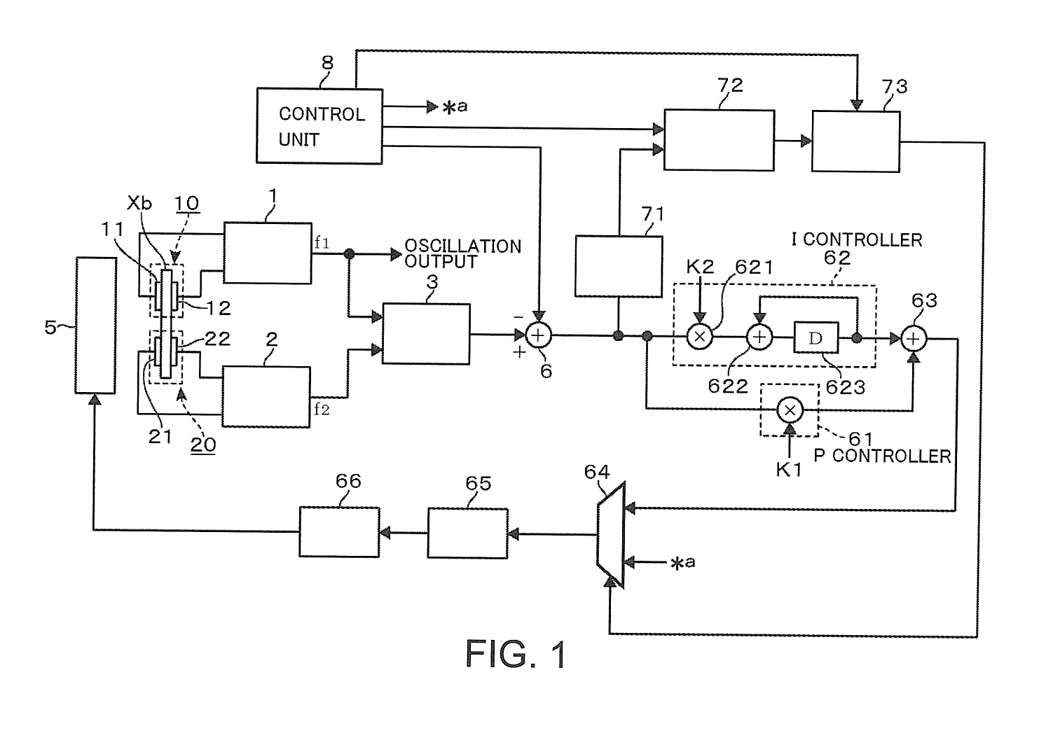

FIG. 1 is a block diagram illustrating a whole temperature controller according to the embodiment of this disclosure. The temperature controller has a function for adjusting a power feeding amount to a heater 5 that controls a temperature of an atmosphere in which crystal units 10 and 20 are placed. The crystal units 10 and 20 are heated bodies provided in a crystal oscillator (OCXO).

The crystal oscillator includes a first crystal unit 10 and a second crystal unit 20. The first crystal unit 10 and second crystal unit 20 use a common crystal element Xb. For example, the strip-shaped crystal element Xb is divided into two areas in the longitudinal direction, then electrodes for vibration-excitation are provided on both front and back surfaces of the respective divided areas (vibration areas). Accordingly, the first crystal unit 10 includes one of the divided areas and a pair of electrodes 11 and 12. The second crystal unit 20 includes the other one of the divided areas and a pair of electrodes 21 and 22. Therefore, the first crystal unit 10 and second crystal unit 20 may be considered to be thermally connected.

The first crystal unit 10 and the second crystal unit 20 are respectively connected to a first oscillator circuit 1 and a second oscillator circuit 2. Both outputs of the oscillator circuits 1 and 2 may be, for example, overtones (higher harmonics) of the crystal units 10 and 20 or also may be the fundamental waves of the crystal units 10 and 20. When the output of overtone is used, for example, a tuning circuit for overtone may be provided in an oscillation loop formed by a crystal unit and an amplifier to cause the oscillation loop oscillate at overtone frequencies. Alternatively, the oscillation loop oscillates a fundamental wave, then the fundamental wave is distorted by a class C amplifier provided at a subsequent stage of an oscillation stage, which is, for example, a subsequent stage of an amplifier that is a part of a Colpitts circuit, and the distorted wave is tuned to an overtone by a tuning circuit provided at a subsequent stage of the class C amplifier. Consequently, both oscillator circuits 1 and 2 may oscillate a wave at the third overtone oscillation frequencies.

Here, for convenience, assuming that a frequency signal having a frequency f1 is output from the first oscillator circuit 1, while a frequency signal having a frequency f2 is output from the second oscillator circuit 2, the frequency signal having the frequency f1 is output from the crystal oscillator as an oscillation output. Reference numeral 3 in FIG. 1 indicates a frequency difference detection unit. A frequency difference detection unit 3 is, to schematically say, a circuit unit to obtain f2−f1−Δfr, which is a difference between Δfr and a difference between f1 and f2. The value Δfr is a difference between f1 (f1r) and f2 (f2r) at a reference temperature, for example, 25° C. For example, one example of difference between f1 and f2 is several MHz. This disclosure comes into effect by calculating a value ΔF, which is a difference between a value corresponding to a difference between f1 and f2 and a value corresponding to a difference between f1 and f2 at a reference temperature, for example, 25° C. using the frequency difference detection unit 3. In particular, the value obtained by the frequency difference detection unit 3 is {(f2−f1)/f1}−{(f2r−f1r)/f1r} in this embodiment.

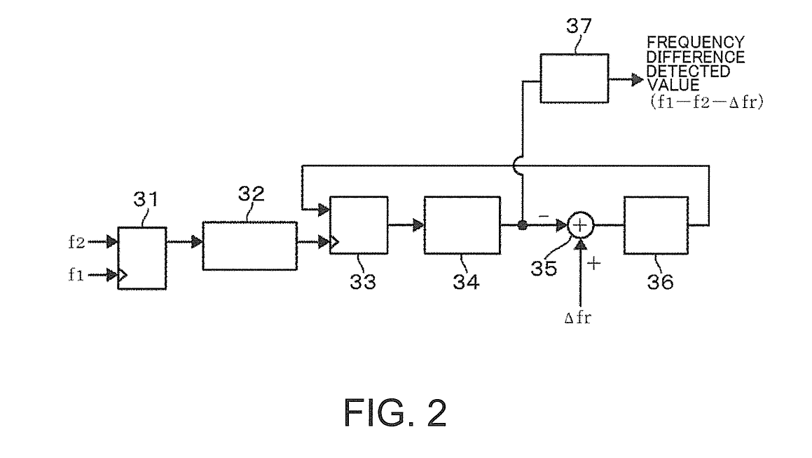

FIG. 2 illustrates a concrete example of the frequency difference detection unit 3. Reference numeral 31 indicates a flip-flop circuit (F/F circuit), which includes two input terminals. A frequency signal having the frequency f1 is input into one of the input terminals of the flip-flop circuit 31 from the first oscillator circuit 1, while a frequency signal having the frequency f2 is input into the other one of the input terminals from the second oscillator circuit 2. The frequency signal having the frequency f2 from the second oscillator circuit 2 is latched by the frequency signal having the frequency f1 from the first oscillator circuit 1. Hereinafter, the f1 and f2 are considered to indicate the frequencies or frequency signals themselves to avoid redundancy of the description. The flip-flop circuit 31 outputs a signal having a frequency (f2−f1)/f1, which is a value corresponding to a frequency difference between f1 and f2.

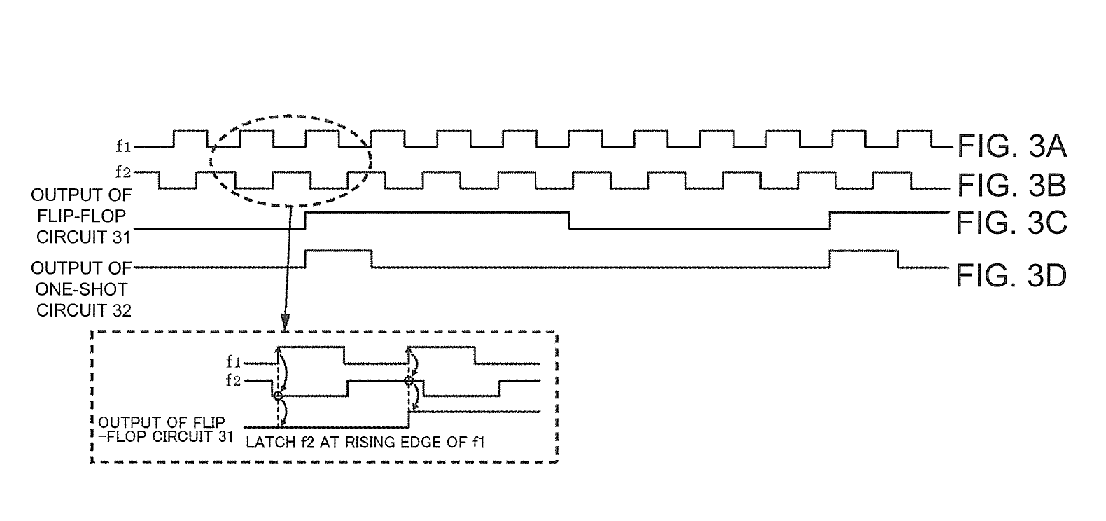

At a subsequent stage of the flip-flop circuit 31, a one-shot circuit 32 is disposed. The one-shot circuit 32 outputs a one-shot pulse at the rising edge of the pulse signal obtained from the flip-flop circuit 31. FIGS. 3A to 3D are timing charts of a series of signals described by this point. The one-shot circuit 32 corresponds to a pulse generation unit disposed in the frequency difference detection unit 3 of this example.

At a subsequent stage of the one-shot circuit 32, a Phase Locked Loop (PLL) is disposed. The PLL includes a latch circuit 33, a loop filter 34 having an integrating function, an addition unit 35, and a direct digital synthesizer (DDS) circuit unit 36. The latch circuit 33 latches a saw-tooth wave output from the DDS circuit unit 36 using a pulse output from the one-shot circuit 32. The output of the latch circuit 33 has a signal level of the saw-tooth wave at a time point when the pulse is output. The loop filter 34 integrates a DC voltage having this signal level. The addition unit 35 adds this DC voltage to a DC voltage corresponding to Δft (a difference between f1 and f2 at a reference temperature, for example, 25° C.). The data of the DC voltage corresponding to Δfr is stored in a memory (not shown).

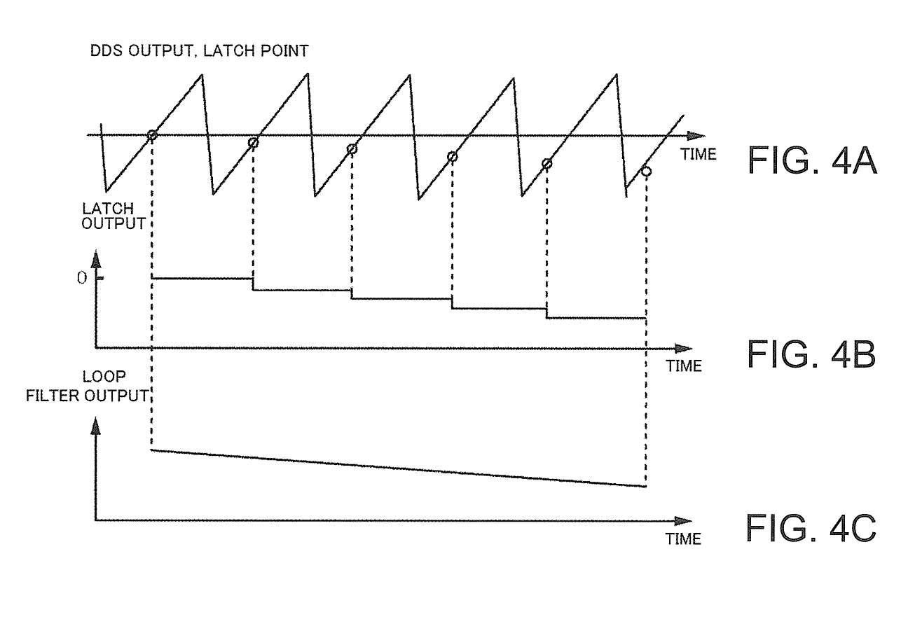

In this example, regarding to signs of the addition unit 35, an input side of a DC voltage corresponding to Mr is “+”, while an input side of an output voltage from the loop filter 34 is “−”. The DDS circuit unit 36 receives the DC voltage computed by the addition unit 35, which is a voltage obtained by subtracting the output voltage of the loop filter 34 from the DC voltage corresponding to Δfr, and the DDS circuit unit 36 outputs a saw-tooth wave having a frequency corresponding to this voltage value. For easy understanding of the operation of the PLL, the outputs of respective portions of the PLL are extremely schematically illustrated in FIG. 4A to FIG. 4C, and are extremely schematically described for intuitive understanding. Immediately after the apparatus is activated, the DDS circuit unit 36 receives a DC voltage corresponding to Δfr, which is, for example, 5 MHz, through the addition unit 35, and the DDS circuit unit 36 outputs a saw-tooth wave corresponding to this frequency.

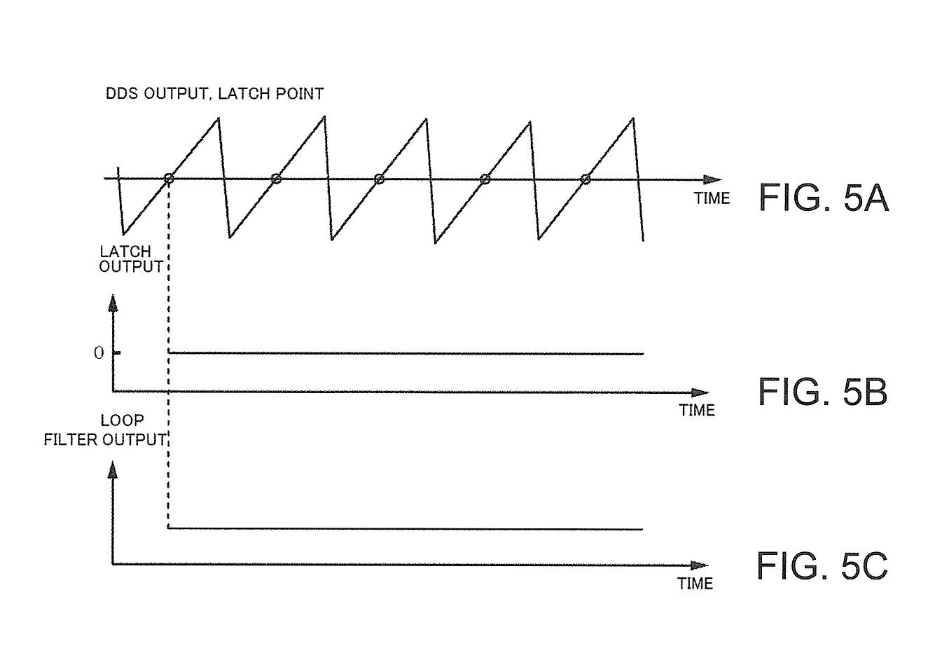

The saw-tooth wave is latched with a pulse having a frequency corresponding to (f2−f1) by the latch circuit 33. If (f2−f1) is, for example, 6 MHz, since a period of the pulse used for latching is shorter than that of the saw-tooth wave, the latch points of the saw-tooth wave gradually lower as shown in FIG. 4A, then the output of the latch circuit 33 and the output of the loop filter 34 gradually decrease to minus side as shown in FIGS. 4B and 4C. Since the sign of the output side of the loop filter 34 in the addition unit 35 is “−”, a DC voltage input from the addition unit 35 to the DDS circuit unit 36 increases. Accordingly, a frequency of the saw-tooth wave output from the DDS circuit unit 36 increases. When a DC voltage corresponding to 6 MHz is input into the DDS circuit unit 36, a frequency of the saw-tooth wave becomes 6 MHz, which locks the PLL as shown in FIGS. 5A to 5C. At this point, a DC voltage output from the loop filter 34 have a value corresponding to Δfr−(f2−f1)=−1 MHz. Namely, it is considered that an integral value of the loop filter 34 corresponds to an integral value of a variation amount of 1 MHz when the saw-tooth wave changes from 5 MHz to 6 MHz.

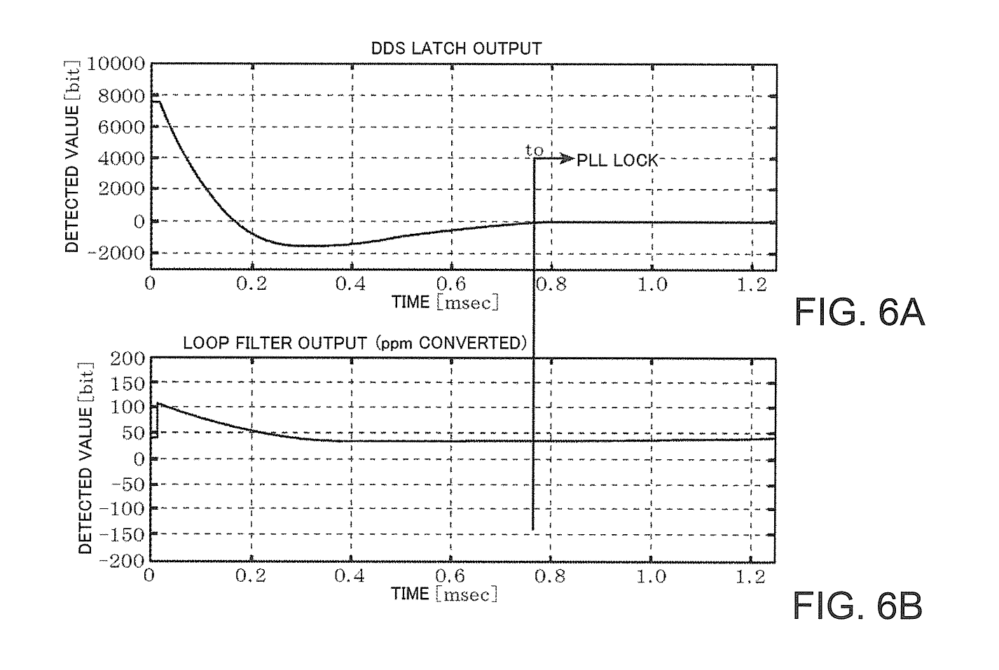

In contrast to this example, if Δfr is 6 MHz and (f2−f1) is 5 MHz, since a period of the pulse used for latching is longer than that of the saw-tooth wave, the latch points shown in FIG. 4A gradually rise, then the output of the latch circuit 33 and the output of the loop filter 34 also increase. This causes a value subtracted at the addition unit 35 increase, then the frequency of the saw-tooth wave gradually decrease, and then reaches 5 MHz, which is the same value as (f2−f1), and the PLL is locked. At this point a DC voltage output from the loop filter 34 has a value corresponding to Δfr−(f2−f1)=1 MHz. Note that FIG. 6A and FIG. 6B illustrate measurement data, and in this example, the PLL is locked at a time point to.

Incidentally, in practice, an output of the frequency difference detection unit 3, or an output of an averaging circuit 37 shown in FIG. 2 has a 34-bit digital value of {(f2−f1)/f1}−{(f2r−f1r)/f1r}. Assuming that the collection of these values from around −50° C. to around 100° C. is (f1−f1r)/f1=OSC1 (unit is ppm or ppb) and (f2−f2r)/f2r=OSC2 (unit is ppm or ppb), a variation relative to the temperature has the substantially same curve as that of OSC2−OSC1. Accordingly, the output of the frequency difference detection unit 3 may be used as OSC2−OSC1=temperature data.

The operation in which f2 is latched with f1 by the flip-flop circuit 31 is asynchronous. This may result in an indefinite interval such as a metastable period (a period when an output is unstable since clock and input data vary approximately simultaneously even though the input data should be held for a certain period of time before and after a time point of the edge at which the latch is performed when the input data is latched at an edge of the clock). Accordingly, the output of the loop filter 34 may include an instantaneous error. Therefore the averaging circuit 37, which computes a moving average of input values within a pre-set period of time, is provided at the output side of the loop filter 34 to remove an instantaneous error even it occurs. Providing the averaging circuit 37 allows to obtain, conclusively, the information on frequency deviation by the temperature variation with high accuracy. However, it is an optional to have a configuration without the averaging circuit 37.

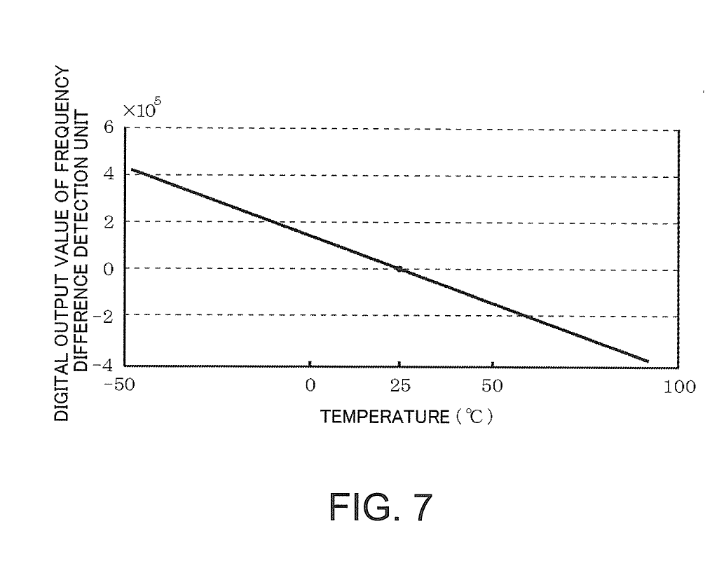

FIG. 7 illustrates a relation between the output of the frequency difference detection unit 3, and the temperature, from which it is understood that the output and the temperature have a linear relation. Accordingly, it may be considered that the output value of the frequency difference detection unit 3 corresponds to the detected value of the temperature in an atmosphere where the crystal units 10 and 20 are placed.

Now returning to FIG. 1, at a subsequent stage of the frequency difference detection unit 3, an addition unit 6 (difference computation unit) is disposed, which retrieves a difference value between an output of the frequency difference detection unit 3 and a temperature setting value (both values are digital signals). The temperature setting value is determined by corresponding to a target temperature of the crystal units 10 and 20, and is set by a control unit 8 that is described below. It is preferred to set the temperature setting value with corresponding to a target temperature by which the OSC1 value obtained from the first crystal unit 10, which is for obtaining an output of the crystal oscillator, is less likely to vary due to temperature change. In the case of the temperature controller of this example, a target temperature is, for example, 50° C.

At a subsequent stage of the addition unit 6, a P controller 61 and an I controller 62 are disposed, which are controllers for computing a manipulated variable for adjusting a power feeding amount to the heater 5, to make the difference value computed by the addition unit 6 zero. The P controller 61 is a multiplier that multiplies the difference value by a proportional gain K1 to obtain a manipulated variable proportional to the difference value. In order to obtain a manipulated variable for canceling the difference value, a negative value is set as the proportional gain K1.

The I controller 62 is an integration circuit for obtaining a manipulated variable proportional to a time integration value of a difference value. The I controller 62 includes a multiplication unit 621, an addition unit 622, and a latch unit 623. The multiplication unit 621 multiplies the difference value by an integration gain K2. The addition unit 622 acquires an output of the latch unit 623 at the subsequent stage, and adds the acquire output to an output of the multiplication unit 621. The latch unit 623 latches the last output of the addition unit 622, outputs the latched value to the addition unit 622 for adding the latched value to the present output of the multiplication unit 621, and outputs this latched value as a manipulated variable. Similarly to the P controller 61, a negative value is set as the integration gain K2.

The outputs of the P controller 61 and the I controller 62 are added at an addition unit 63, and are input into a PWM interpolation unit 65 through a selector 64 that is described below. The PWM interpolation unit 65 converts a 14-bit digital signal (two's-complement from −2¹³ to +2¹³) into representation of a pulse signal during a certain period of time. For example, when the minimum H pulse width is 10 nsec, a digital signal is expressed with a pulse number during a certain period of time, which is 2¹⁴*10⁻⁹=16.384 msec. Specifically, the pulse numbers are expressed as follows: The number of H pulses during 16.384 ms is 2¹³ when a 14-bit digital value is zero; The number of H pulses during 16.384 ms is zero when a 14-bit digital value is −2¹³; The number of H pulses during 16.384 ms is 2¹⁴−1 when a 14-bit digital value is 2¹³

At a subsequent stage of the PWM interpolation unit 65, a low pass filter (LPF) 66 is disposed. The LPF 66 averages an output of the PWM interpolation unit 65, and outputs a DC voltage corresponding to the number of pulses that is the output of the PWM interpolation unit 65. Namely, in this example, the PWM interpolation unit 65 and the LPF 66 are provided for converting a digital value into an analog value. A digital-analog converter may be used instead of using the PWM interpolation unit 65 and the LPF 66.

At a subsequent stage of the LPF 66, a heater 5 is disposed, which corresponds to a heating unit. The heater 5 receives the power corresponding to output from the LPF 66. The heater 5 can control a heating temperature in response to the amount of the provided power, and can control the temperature of crystal units 10 and 20. For example, the heater 5 includes a transistor and a resistor. The transistor has a base connected to the output terminal of the LPF 66, and a collector to which a voltage is supplied from a power source unit (not shown). The resistor is connected between an emitter of the transistor and the ground. The relation between the voltage supplied to the base of the transistor, and the total power of the power consumption of the transistor and the power consumption of the resistance is linear relation. This allows a linear control of the heating temperature of the heater 5 based on the manipulated variable computed by the P controller 61 and the I controller 62. In this example, the transistor is also a part of the heater 5, and the crystal units 10 and 20 and the heater 5 are housed in a common housing.

The temperature controller thus configured has a function to stop power feeding to the heater 5 when the temperature controller determines that an abnormal event occurs in the temperature control. The following describes the configuration of the function. Regarding to the above-described function, the temperature controller includes an absolute value conversion unit 71, a digital comparator 72, a timer 73, the selector 64, and a control unit 8. The absolute value conversion unit 71 converts an output of the addition unit 6 into an absolute value. The digital comparator 72 compares the absolute value of the difference value obtained by the absolute value conversion unit 71 with a pre-set threshold value. The timer 73 determines whether or not that a period of time in which the absolute value continues to exceed the threshold value is within a pre-set period of time. The selector 64 stops power feeding to the heater 5 based on the determination result by the timer 73. The control unit 8 outputs setting signals to the addition unit 6, the digital comparator 72, and the timer 73.

The absolute value conversion unit 71 receives the output of the addition unit 6 (difference value), which is also input to the P controller 61 and the I controller 62, and converts the received value into the absolute value, then outputs the converted value to the digital comparator 72 at the subsequent stage of the absolute value conversion unit 71. When a temperature detection value detected by the frequency difference detection unit 3 is equal to the temperature setting value, an output of the absolute value conversion unit 71 becomes zero.

The digital comparator 72 compares the absolute value of the difference value obtained from the absolute value conversion unit 71 with the threshold value, which is a digital signal set by the control unit 8. When the absolute value exceeds the threshold value, the digital comparator 72 outputs a signal (first signal) to the tuner 73, which indicates that the absolute value exceeds the threshold value. For example the digital comparator 72 outputs a value “0” to the timer 73 when the absolute value does not exceed the threshold value, while the digital comparator 72 outputs a value “1” to the timer 73 when the absolute value exceeds the threshold value. In the temperature controller of this example, for example, a value within a range from ±1° C. to ±10° C. with respect to the target value is set as the threshold value. In this point of view, the absolute value conversion unit 71 and the digital comparator 72 correspond to a comparison unit of this embodiment.

The timer 73 compares a duration time in which the first signal (a signal indicating that the absolute value of the difference value exceeds the threshold value) continues to be input from the digital comparator 72, with the pre-set period of time set by the control unit 8. When the duration time exceeds the pre-set period of time, the timer 73 output an abnormal detection signal (second signal) to the selector 64, the abnormal detection signal indicates that the duration time exceeds the pre-set period of time. For example, the timer 73 outputs a value “0” to the selector 64 when the duration time does not exceed the pre-set period of time, while the timer 73 outputs a value “1” to the selector 64 when the duration time exceeds the pre-set period of time. In the case of the temperature controller of this example, for example, a value within a range from 10 seconds to 600 seconds is set as the pre-set period of time. The timer 73 corresponds to an abnormal detection unit of this embodiment.

The selector 64 switches signals, which is output from the selector 64 to the PWM interpolation unit 65, between: the manipulated variable output from the P controller 61 and the I controller 62; and a signal for stopping power feeding to the heater 5 based on the output of the timer 73. The control unit 8 sets the signal for stopping power feeding to the heater 5. For example, the control unit 8 inputs a signal that makes an output of the PWM interpolation unit 65 a value “0” (indicated as “*a” in FIG. 1).

Then, the selector 64 outputs the manipulated variable, which is obtained from the P controller 61 and the I controller 62, to the PWM interpolation unit 65 when the selector 64 receives a value “0” from the timer 73 (when the duration time does not exceed the pre-set period of time). While, the selector 64 outputs the signal for stopping power feeding to the heater 5 to the PWM interpolation unit 65 when the selector 64 receives a value “1”, which is an abnormal detection signal (when the duration time exceeds the pre-set period of time). In this point of view, the selector 64 corresponds to a power feeding stopping unit of this embodiment.

The following describes the operation of the exemplary temperature controller having the above-described configuration. First, when focusing on the crystal oscillator in which the temperature controller controls a temperature of the crystal units 10 and 20, the oscillation output of the crystal oscillator corresponds to a frequency signal output from the first oscillator circuit 1 as described above. The atmosphere in which the crystal units 10 and 20 are placed is heated to a target temperature by the heater 5. The first crystal unit 10 and the first oscillator circuit 1 generate a frequency signal, which is the output of the crystal oscillator, as well as have a role as a temperature detection unit for detecting a temperature value with the second crystal unit 20 and the second oscillator circuit 2. A value OSC2−OSC1 (output of the frequency difference detection unit 3), which is the frequency difference between the frequency signals respectively obtained from the oscillator circuits 1 and 2, corresponds to a temperature detection value as described above. Then a difference value between the value OSC2−OSC1 and a temperature setting value (for example, value OSC2−OSC1 at 50° C.) is retrieved at the addition unit 6.

The manipulated variable is computed based on this difference value by the P controller 61 and the I controller 62, and is output to the PWM interpolation unit 65 and the LPF 66 via the selector 64, and is converted into a DC voltage, which adjusts a control power of the heater 5. A power feeding amount to the heater 5 is decreased by the manipulated variable when the temperature of the crystal units 10 and 20 exceeds a target temperature (50° C. in this example), while the power feeding amount to the heater 5 is increased when the temperature of the crystal units 10 and 20 does not exceed the target temperature. Consequently, this attempts to maintain the temperature of the atmosphere in which the crystal units 10 and 20 are placed at 50° C., which is the target temperature, then the output frequency from the first oscillator circuit 1, which is the oscillation output, is stabilized.

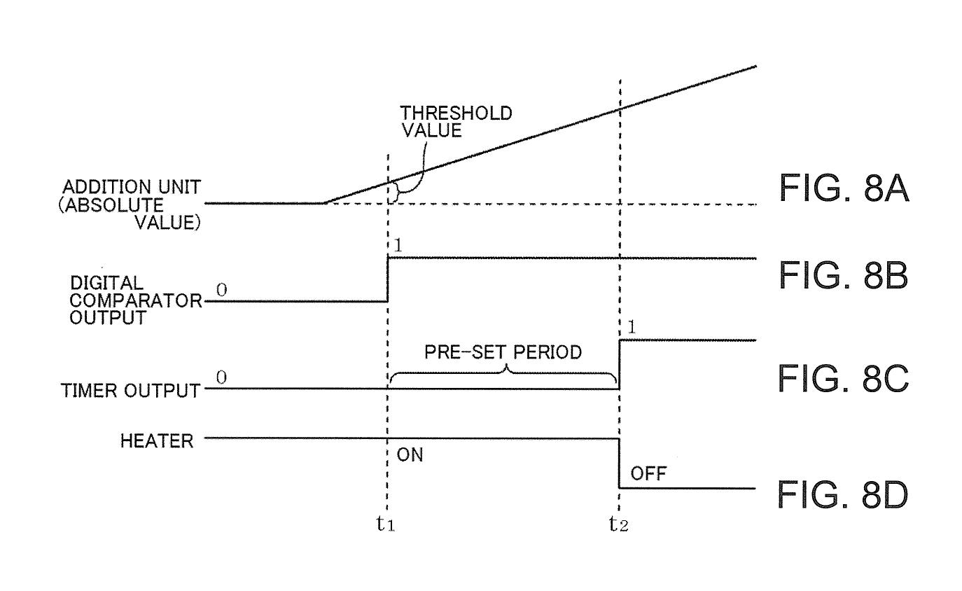

Incidentally, the difference value (output of the addition unit 6) between the output from the frequency difference detection unit 3 and the temperature setting value is converted into the absolute value by the absolute value conversion unit 71, and monitored by the digital comparator 72. For example, it is assumed that the temperature cannot be controlled appropriately due to the failure of an electronic circuit and the heater 5 or any other troubles, and the output of the addition unit 6 starts to increase with time as shown in FIGS. 8A to 8D. At a time point (time t1) when the absolute value of the difference value output from the addition unit 6 exceeds the pre-set threshold value, the digital comparator 72 outputs the first signal “1” to the timer 73. The first signal indicates that the absolute value exceeds the threshold value.

The timer 73 measures a period of time in which the first signal continues to be input from the digital comparator 72 (duration time), and compares the measured period of time with the pre-set period of time. At a time point (time t2) when the duration time exceeds the pre-set period of time, the timer 73 outputs the second signal “1” to the selector 64. The second signal “1” indicates that the duration time exceeds the pre-set period of time. At a time when the selector 64 receives the second signal, the selector 64 switches the output signal for the PWM interpolation unit 65, from the manipulated variable computed by the P controller 61 and the I controller 62, to the setting value (a signal that makes an output from the PWM interpolation unit 65 a value “0”) output from the control unit 8. Consequently, this stops power feeding to the heater 5. Note that when a digital-analog conversion circuit is provided instead of the PWM interpolation unit 65 and the LPF 66, an analog output is made zero.

The temperature controller according to the embodiment has the following the effect. When controlling the temperature of the crystal units 10 and 20 heated by the heater 5 to the pre-set temperature, the temperature controller compute the manipulated variable for making the difference value between the temperature detection value and the temperature setting value zero using the P controller 61 and the I controller 62, then determines the power feeding amount to the heater 5 based on the computation result. Accordingly, focusing on that the difference value is near zero in normal operation, but becomes larger than that of normal operation when the temperature is not controlled appropriately, the temperature controller determines that an abnormal event occurs in the temperature control when a period of time in which this value continues to exceed the threshold value exceeds the pre-set period of time, then stops power feeding to the heater 5. Therefore, the temperature controller determines whether or not that the difference value between the temperature detection value and the temperature setting value exceeds the predetermined threshold value, instead of determining whether or not that the temperature detected by a thermistor or any other sensors exceeds the threshold value. Accordingly, the threshold value corresponding to the state where the temperature is not controlled appropriately may be set easily with high accuracy.

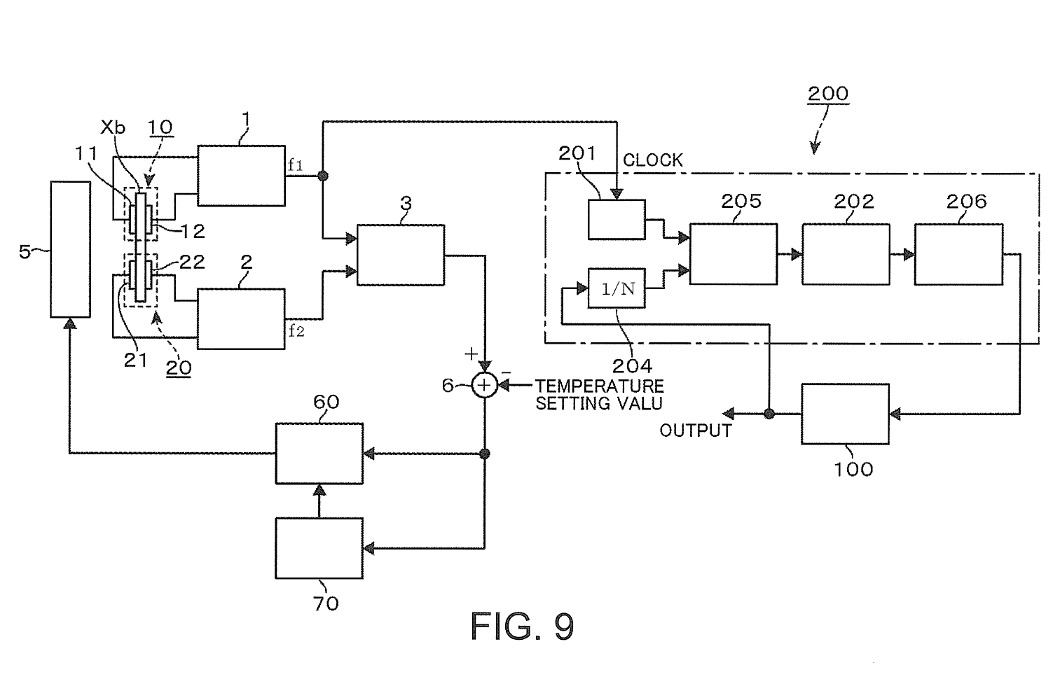

FIG. 9 is a block diagram illustrating an oscillating device including the temperature controller of this example and the crystal oscillator in which the temperature of the crystal units 10 and 20 is controlled by the temperature controller. In FIG. 9, the components same as those indicated in FIG. 1 are given the same reference numerals as those of FIG. 1. The P controller 61, the I controller 62, the addition unit 63, the selector 64, the PWM interpolation unit 65, and the LPF 66 indicated in FIG. 1 are indicated as a heater control circuit 60 in FIG. 9. Similarly, the digital comparator 72 and the timer 73 are indicated as a heater abnormality detection circuit 70.

As shown in FIG. 9, the oscillating device includes a control circuit unit 200 constituting a PLL that operates using a frequency signal from the first oscillator circuit 1 as a clock signal. The oscillating device works as a frequency synthesizer that outputs a frequency signal having a pre-set frequency. At a phase frequency comparison unit 205, the control circuit unit 200 compares a phase of reference clock (for reference) output from a DDS circuit unit 201 with a phase of clock that is an output from a voltage-controlled oscillator 100 and divided by a dividing unit 204. The phase difference as the comparison result is converted into an analog signal by a charge pump 202. The converted analog signal is input into a loop filter 206, and the phase locked loop (PLL) is controlled to be stabilized.

Accordingly, it may be said that the control circuit unit 200 is a PLL unit. Here, the DDS circuit unit 201 uses a frequency signal output from the first oscillator circuit 1 that is described below as a reference clock, and frequency data (digital value) for outputting a signal having a target frequency is input to the DDS circuit unit 201.

The following describes a variation of the above-described embodiment. The controllers are not limited to a configuration of the P controller 61 and the I controller 62. It is possible to further provide a D controller that performs differential control, or to provide a loop filter, which is an integration circuit, instead of these PID-controllers. In addition, having the absolute value conversion unit 71 is not an essential requirement for the comparison unit. It is possible to provide a comparison unit, which determines whether or not that a difference value is within the threshold range having the upper limit value and the lower limit value, and outputs the first signal when the difference value is out of this threshold range. Furthermore, a power feeding stopping unit is not limited to a configuration having the selector 64. It is possible to provide a switch circuit, which performs open-close operation based on the second signal output from the timer 73.

Furthermore, in the above-described embodiment, a digital circuit is described, which uses, as a digital signal, the temperature detection value, the temperature setting value, the difference value between the temperature detection value and the temperature setting value, and the threshold value with which the difference value is compared. However, use of these signals as a digital signal is not an essential requirement. It is obvious that an analog circuit may be used, which uses some of these signals or all of these signals as an analog signal.

In addition, a heated body whose temperature can be controlled by the temperature controller of this disclosure is not limited to an electronic device such the crystal units 10 and 20. It is possible to use, for example, an optical component such as an arrayed-waveguide grating.

What is claimed is:

1. A temperature controller for controlling a temperature of a heated body heated by a heater to a target temperature, the temperature controller comprising:
a temperature detection unit, configured to detect the temperature of the heated body;
a difference computation unit, configured to compute a difference value between a temperature detection value detected by the temperature detection unit, and a temperature setting value corresponding to the target temperature;
a controller, configured to compute a manipulated variable to make the difference value computed by the difference computation unit zero;
a comparison unit, configured to compare the difference value computed by the difference computation unit with a pre-set threshold value set for detecting an abnormal event in the temperature control, and output a first signal when the difference value exceeds the threshold value;
an abnormal event detection unit, configured to output a second signal that is an abnormal event detection signal when the first signal continues to be output for a period of time exceeding a pre-set period of time; and
a power feeding stopping unit, configured to stop power feeding to the heater when the second signal is output, wherein
a power feeding amount to the heater is controlled based on the manipulated variable computed by the controller.

2. The temperature controller according to claim 1, wherein
the heated body is an electronic component.

3. The temperature controller according to claim 1, wherein
the controller computes the manipulated variable with respect to the difference value by PI operation.

4. The temperature controller according to claim 1, wherein
the difference computation unit is configured to output the difference value as a digital signal,
the temperature setting value and the difference value are digital signals, and
the comparison unit compares the threshold value as a digital signal with the difference value.

5. The temperature controller according to claim 4, wherein
the temperature detection unit includes:
a first crystal unit including a first electrode provided on a crystal element;
a second crystal unit including a second electrode provided on the crystal element;
a first oscillator circuit and a second oscillator circuit respectively connected to the first crystal unit and the second crystal unit; and
a frequency difference detection unit configured to compute, as the temperature detection value, a value corresponding to a difference value between a value corresponding to a difference between f1 and f1r, and a value corresponding to a difference between f2 and f2r, assuming that an oscillation frequency of the first oscillator circuit is f1, an oscillation frequency of the first oscillator circuit at a reference temperature is f1r, an oscillation frequency of the second oscillator circuit is f2, an oscillation frequency of the second oscillator circuit at the reference temperature is f2r,
wherein the frequency difference detection unit includes:
a pulse generation unit, configured to generate a pulse having a frequency corresponding to a difference between f1 and f2;
a DDS circuit unit, configured to output a frequency signal whose signal value repeatedly increases and decreases with time at a frequency in response to an magnitude of an input DC voltage;
a latch circuit, configured to latch the frequency signal output from the DDS circuit unit using the pulse generated by the pulse generation unit;
a loop filter, configured to integrate a signal value latched by the latch circuit, and outputs the integrated value as a value corresponding to the difference value; and
an addition unit, configured to extract a difference between an output of the loop filter and a value corresponding to a difference between f1r and f2r, and set the extracted difference as an input value to the DDS circuit unit,
wherein the heated body heated by the heater is the crystal units.

6. The temperature controller according to claim 5, wherein
the first crystal unit and the second crystal unit are provided on a common crystal element.

7. The temperature controller according to claim 1, wherein
the heater is a transistor including: a collector connected to a power source unit; a base receiving power from the temperature controller; and an emitter connected to the ground via a resistor.

8. The temperature controller according to claim 1, wherein
the comparison unit is configured to convert the difference value computed by the difference computation unit into an absolute value, and compare the absolute value with the threshold value.

9. The temperature controller according to claim 1, wherein
the threshold value is set to a value within a range of ±10° C. from the temperature setting value.

10. The temperature controller according to claim 1, wherein
the pre-set period of time is set as a value within a range from 10 seconds to 600 seconds.
